(19) United States
(12) Patent Application Publication
(10) Pub. No.: US 2008/0235421 A1
(43) Pub. Date: Sep. 25, 2008

(54) Technique and apparatus to optimize inter-port memory transaction sequencing on a multi-ported memory controller unit

(76) Inventors: Siva Shankar Jayaratnam, Kuala Lumpur (MY); Jin Ming Kam, Perak (MY)

Correspondence Address: TROP PRUNER & HU, PC, 1616 S. VOSS ROAD, SUITE 750, HOUSTON, TX, 77057-2631, US

(21) Appl. No.: 11/726,570

(22) Filed: Mar. 22, 2007

(51) Int. Cl. G06F 13/00

(52) U.S. Cl. 710/110

(57) ABSTRACT

An apparatus that includes a multi-ported memory controller unit to control access to a memory external to the memory controller and comprising port interfaces coupled to the masters. Each master is capable of generating a transaction request with the memory. The apparatus also includes a transaction sequence logic to communicate with the masters using sideband signals to receive the transaction request and apply rules to control access to the memory by the masters

### BACKGROUND

The invention generally relates to a technique and apparatus to optimize inter-port memory transaction sequencing on a multi-ported memory controller unit.

A typical computer system may include a multi-ported memory. In this type of memory, the same page of memory may be read and written simultaneously. Due to the concurrent accesses, the computer system typically implements measures to prevent coherency problems. Traditional measures to preserve coherency may encounter challenges related to maintaining a desired ordering of the transactions, preventing network lockup and preventing poor memory bandwidth utilization, as examples.

### BRIEF DESCRIPTION OF THE DRAWING

FIG. 1 is a schematic diagram of a memory subsystem and associated masters that access the memory subsystem according to an embodiment of the invention.

FIG. 2 is an illustration of a transaction sequencer table used by a memory controller unit of the memory subsystem according to an embodiment of the invention.

FIG. 3 is a flow diagram depicting a technique to sequence transactions that target a multi-ported memory of the memory subsystem according to an embodiment of the invention.

### DETAILED DESCRIPTION

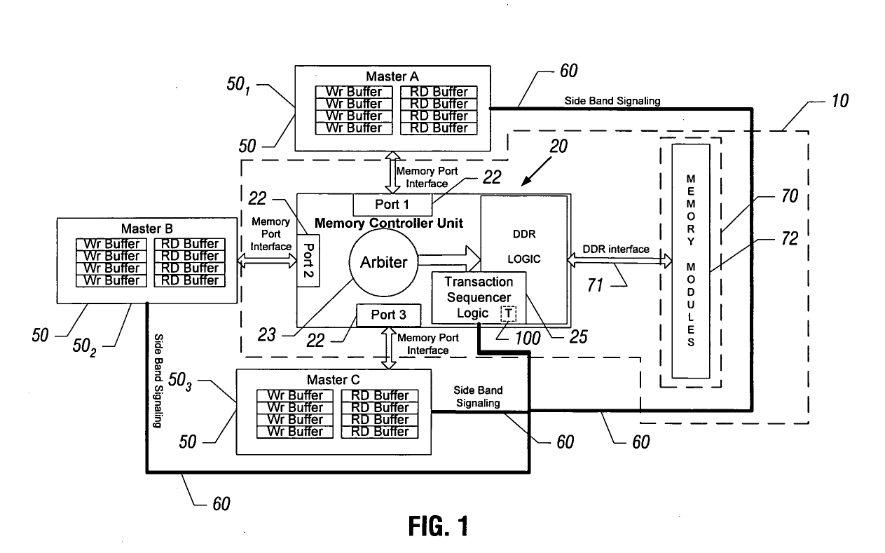

FIG. 1 generally depicts an exemplary memory subsystem 10 in accordance with embodiments of the invention. In general, the memory subsystem 10 may be part of a larger computer system that has masters 50 (masters 50₁, 50₂ and 50₃ being depicted as examples), such as microprocessors and/or processing cores (as examples). The masters 50 generate write transactions that target a memory 70 (a memory 70 formed from memory modules 72, for example) of the memory subsystem 10, and a multi-ported memory controller unit (MCU) 20 of the memory subsystem controls access between the masters 50 and the memory 70. The memory 70 may be a dynamic random access memory (DRAM), in accordance with some embodiments of the invention. The MCU 20 may contain multiple memory ports 22, where each memory port 22 is coupled to one of the masters 50. Each master 50 may contain an N item (“N deep”) buffer to hold outstanding transactions.

Maintaining coherency between the ports 22 may be quite challenging, especially when the buffers in the masters 50 are designed to be deep (i.e., for the scenario in which “N” is large) for purposes of hiding memory latency problems due to the pipelining of consecutive transactions in the master 50. A deep buffer in each master 50 generally increases the complexity of maintaining coherency between the memory ports 22. Problems that typically arise when deep buffers are used may involve one or more of the following.

A memory port incoherency issue could occur for the scenario in which the ordering of transactions among the ports 22 is not as intended. For example, a programmer may require that a read transaction to a particular memory address from one port should not be allowed to be overtaken by a write transaction to the same memory address by another port. Hence, the memory controller unit needs to be aware of such an intention by the programmer and somehow be able to maintain this ordering to ensure coherency is maintained.

Memory lock up issues may also potentially occur with the use of deep buffers. In general, a lock up may occur when two or more separate masters are trying to write to the same memory address location and the system is using simple sideband signals to indicate a write hit (write address collision) has occurred. This signal is toggled based on the status of one master 50 snooping the other masters' transaction queues to determine if the target address also exists in these queues. If the master determines that there is an address collision, the master asserts the write hit signal, and then, the master enters a wait state to allow the existing transaction in the other master to be completed first. In the case where two or more masters perform the snoop at the same time, all the masters may enter the wait mode, thereby resulting in, and then a lock up.

Poor memory bandwidth utilization may potentially occur with the use of deep buffers. For example, if the MCU does not try to optimize transactions from each port by grouping transactions to the same page in consecutive order, then constant page switching may arise, where pages are open and closed very often and hence impacting overall memory bandwidth utilization. Overall this would have a negative impact on the memory access latency times.

Referring to FIG. 1, in accordance with embodiments of the invention described herein, to avoid one or more of the problems that may arise due to having deep buffers in the masters 50, the MCU 20 has transaction sequencer logic 25. Before a master 50 communicates a read or write transaction to one of the memory ports 22, the master 50 communicates with the transaction sequencer logic 25 via an associated sideband signaling channel 60 for purposes of permitting the transaction sequencer logic 25 to control the sequence in which the transaction occurs.

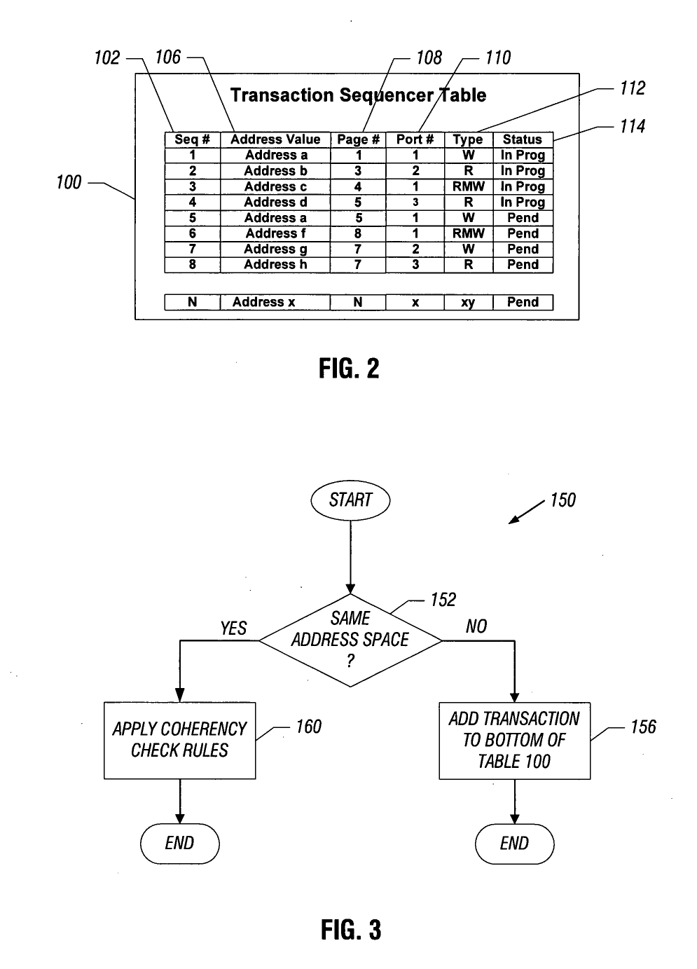

The function of the transaction sequencer logic 25 is to provide an inter-port MCU arbiter 23 of the MCU 20 with the decision on which memory port 22 to be granted access to utilize the MCU's interface 71 to the memory 70. The transaction sequencer logic 25 contains a transaction sequencer table (TST) 100, which is depicted in more detail in FIG. 2.

Referring to FIGS. 1 and 2, the TST 100 keeps track of every outstanding transaction that is currently pending in the buffers of the masters 50 that are connected to the memory ports 22.

In accordance with some embodiments of the invention, each entry in the TST 100 contains six key tags for each transaction: a sequence number 102; a memory address space 106; corresponding memory opened pages 108 (i.e. if a memory access is to a page that is not open then its marked as unknown) the transaction is trying to access; the port number 110 where this transaction is currently waiting; an access type 112 of the transaction (i.e., “R—read”, “W—write” or “RMW—read modify write”); and a status 114 of the transaction (i.e., “In Prog—its currently accessing the memory interface” and “Pend—its still awaiting grant from the arbiter”). Each transaction is ordered according to the priority, given by the sequence number field 102. Based on this order, the arbiter 23 selectively grants access to each memory port 22 accordingly.

As each master 50 receives a new memory transaction request, the master 50 sends information pertaining to transaction address, transaction type and port number to the transaction sequence logic 25 via the side band signal channel 60. Hence, snooping between masters 50 is not performed, as the side band signals directly connect to the transaction sequencer logic 25 within the MCU 20.

When the master 50 updates the MCU 20 with a new transaction request, the transaction sequence logic 25 attempts to insert this new request into the TST 100 using a specific pre-defined set of rules. The TST 100 look up is performed for pending accesses to same address space (within the same memory page space). If a match occurs, then the transaction rules are applied to determine which of the transactions should be held and which should be allowed to proceed by reordering the sequence number field 102 and updating the status field 114 in the TST 100. If a match does not occur, then the transaction is added to the bottom of the TST 100 with a corresponding sequence number and status.

FIG. 3 depicts a technique 150 that may be used by the MCU 20 in accordance with some embodiments of the invention to process transactions. The technique 150 includes determining (diamond 152) whether an address space match has occurred (i.e., whether the current transaction is the same address space as another pending transaction). If not, then the transaction is added to the bottom of the table 100, pursuant to block 156. Otherwise, coherency check rules are applied, pursuant to block 160.

As an example, the transaction rules that may apply may include the following. Writes and reads to locations with no coherency check events occur in order of arrival. For a coherency check event, reads must allow writes to proceed; read modify write (RMW) transactions must not be interrupted; and writes occur in order of arrival. Additional page optimization rules may include the following. If writes (with the same data size) to the exact same location by different masters occur, the first transaction is acknowledged dropped; and the data from the later transaction is written out to memory. This rule is superseded by the RMW rules. If there are transactions by multiple masters 50 to addresses on the same open memory page, these transactions are grouped and taken out of incoming queue order and processed together for purposes of minimizing the number of page openings and closings.

By applying these results, a transaction may be added anywhere in the TST 100, as opposed to being added at the bottom of the TST 100 using a first in first out algorithm.

Advantages of the above-described handing of the transactions may include one or more of the following. The MCU 20 has full visibility into the incoming transaction queues, which allows it to effectively sequence events and prevent lock up conditions. The design is more portable than conventional arrangements, as the coherency checking is done in the MCU 20 without private sideband signals going between the individual masters 50. The design is easily scalable as only the TST 100 needs to be expanded to cater new masters 50. The total efficiency of the memory accesses is increased, as the scheme that is described herein allows reordering of transactions to take advantage of currently open pages. The overhead requirements of closing/opening pages for every different transaction is minimized. The MCU 20 efficiency may be more efficiently and accurately measured. Because all active and pending transactions for all the masters 50 are updated in the TST 100, signals from TST 100 are sufficient for purposes of determining performance of the MCU 20 with respect to latency, transaction time for each pending transaction, bandwidth utilization, paging open/close occurrence, etc. The signals from the TST 100 may be hooked up to a performance monitoring unit (PMU) such that performance may be monitored for different software applications.

The logical elements that are disclosed herein may be hardware or firmware, and they may be a part of a processor or chipset, as examples. Thus, many variations are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An apparatus comprising:
a multi-ported memory controller unit to control access to a memory external to the memory controller and comprising port interfaces coupled to masters, each master being capable of generating a transaction request with the memory; and
transaction sequence logic to communicate with the masters using sideband signals to receive the transaction request and apply rules to control access to the memory by the masters.

2. The apparatus of claim 1, wherein the transaction sequencer logic performs a coherency check and allows transactions that do not conflict with another transaction to proceed based on order of arrival.

3. The apparatus of claim 2, wherein the transaction logic, if a conflict occurs, applies additional rules.

4. The apparatus of claim 3, wherein the transaction sequencer logic, if a conflict occurs, allows write transactions to proceed before read operations.

5. The apparatus of claim 3, wherein the transaction sequencer logic, if a conflict occurs, allows read modify write transactions to not be interrupted.

6. The apparatus of claim 3, wherein the transaction sequencer logic, if a conflict occurs, allows write transactions to occur in order of arrival.

7. A method comprising:
providing transaction sequencer logic in a multi-ported memory controller unit, which controls access to a memory external to the memory controller unit for at least one master, each master being capable of generating a transaction request with the memory; and
using the transaction sequence logic to communicate with the masters with sideband signals to receive the transaction request and apply rules to control access to the memory by the masters.

8. The method of claim 7, further comprising:
performing a coherency check and allowing transactions that do not conflict with another transaction to proceed based on order of arrival.

9. The method of claim 8, further comprising:
applying additional rules in response to a conflict occurring.

10. The method of claim 9, further comprising:
allowing write transactions to proceed before read operations if a conflict occurs.

11. The method of claim 9, further comprising:
allowing read modify write transactions to not be interrupted if a conflict occurs.

12. The method of claim 9, further comprising:
allowing write transactions to occur in order of arrival if a conflict occurs.
